(19) United States
(12) Patent Application Publication
(10) Pub. No.: US 2019/0219783 A1
(43) Pub. Date: Jul. 18, 2019

(54) MULTI-FIBER UNIT TUBE OPTICAL FIBER MICROCABLE INCORPORATING ROLLABLE OPTICAL FIBERS RIBBONS

(71) Applicant: OFS Fitel, LLC, Norcross, GA (US)

(72) Inventors: Heng Ly, Stone Mountain, GA (US); Peter A. Weimann, Atlanta, GA (US); Henson P. Toland, Atlanta, GA (US)

(73) Assignee: OFS Fitel, LLC, Norcross, GA (US)

(21) Appl. No.: 15/869,192

(22) Filed: Jan. 12, 2018

(51) Int. Cl. G02B 6/44; G02B 6/36; G02B 6/38

(52) U.S. Cl. CPC G02B 6/4403; G02B 6/3873; G02B 6/3696

(57) ABSTRACT

Embodiments of the invention include an optical fiber cable. The optical fiber cable includes at least one multi-fiber unit tube. The multi-fiber unit tube is substantially circular and dimensioned to receive a plurality of optical fibers. The optical fiber cable also includes at least one rollable optical fiber ribbon comprising a plurality of optical fibers positioned within the at least one multi-fiber unit tube. The plurality of optical fibers in the at least one rollable optical fiber ribbon are rolled in such a way that the at least one rollable optical fiber ribbon is formed in a variable shape. The optical fiber cable also includes a jacket surrounding the at least one multi-fiber unit tube.

### BACKGROUND OF THE INVENTION

### Field of Invention

The invention relates to optical fiber cables. More particularly, the invention relates to optical fiber cables having optical fiber ribbons therein.

### Description of Related Art

Conventionally, loose tube microcables typically are defined as cables that use buffer tubes and that have optical fiber densities of at least approximately 4.2 fibers/millimeter². Such fiber density is based on the optical fiber count (e.g., 12 optical fibers) and the nominal buffer tube outer diameter (e.g., 1.9 millimeters (mm)) of a conventional microcable, such as a MiDia FX+ cable manufactured by OFS Fitel.

However, a more practical density metric is the ratio of optical fiber cross-sectional area to buffer tube cross-sectional area. This density metric becomes particularly useful when discussing various optical fiber sizes, e.g., 250 micron diameter fiber and the recently introduced 200 micron diameter fiber. The MiDia FX+ cable discussed above uses twelve 250 micron diameter fibers per 1.9 millimeter outer diameter buffer tube, and thus the ratio of optical fiber cross-sectional area to buffer tube cross-sectional area is approximately 0.21.

Microcables typically are intended to be used in air-blown applications, i.e., within ducts, and specifically within microducts. The locations in which these ducts are installed generally have space that is at a premium in terms of scarcity and/or cost. Resultantly, the space inside these ducts is also quite limited, thus placing a relatively major constraint on the size of the cables that can be installed therein. Because the cable size is constrained, a way to increase optical fiber density in a duct is to pack more optical fibers into the cables that meet this size constraint.

Recent examples of increasing optical fiber density in loose tube microcables include the progressive development of microcables with buffer tubes having an outer diameter of 1.7 mm and containing twelve 250 micron diameter optical fibers, microcables with buffer tubes having an outer diameter of 1.5 mm and containing twelve 250 micron diameter optical fibers, and microcables with buffer tubes having an outer diameter of 1.7 mm but with twice as many optical fibers per buffer tube, which is accomplished using optical fibers with an outer diameter of 200 microns. Through this development, one can observe the increased fiber density by either cable size reduction or increased fiber count per buffer tube (and subsequently per cable).

With regard to increasing optical fiber count per buffer tube, one limitation is the identification of optical fibers based on color. In North America, colors for identification of fibers are defined in ANSI/TIA-598-D-2014—“Optical Fiber Cable Color Coding.” This standard is referenced by industry cable standards, such as Telcordia GR-20, and notably the first edition of ICEA S-122-744 (U.S. national standard for microduct cable. There are 12 distinct optical fiber colors defined in TIA-598 that are commonly used in the industry (although there have been some proposals to extend that to 16 optical fiber colors). Presently, ANSI/TIA-598-D-2014 requires that any extension beyond 12 optical fibers within a tube identify fibers 1-12 using the 12 distinct colors, then use unique tracer identification for additional fibers beyond 12. This tracer identification typically takes the form of ring-marking of the optical fiber, where identification marks are applied with an ink-jet printer or other suitable means. In such cases, optical fibers 1-12 are the standard colors defined in ANSI/TIA-598-D-2014, optical fibers 13-24 are the same colors as fibers 1-12 but have a single repeating mark as a tracer, optical fibers 25-36 are the same colors as fibers 1-12 but have two repeating marks as a tracer, etc. However, adding these tracers is undesirable because adding the tracers adversely affect the manufacturability and the quality of the optical fiber itself. One manufacturability issue is that ring-marks are generally applied at relatively low line speeds compared to the standard optical fiber coloring process. One quality issue is that the printed ink marks can act as point defects on the optical fiber, which increase signal attenuation.

For higher fiber count optical fiber cables, a typical solution used to increase density is through use of flat optical fiber ribbons. Note that an advantage of flat optical ribbons over loose optical fibers is the ability to use mass fusion splicing, in which a plurality of fibers can be spliced at once, increasing worker efficiency during installation. However, with regard to use in microcable applications, stacked flat optical fiber ribbons disallow tight-packing of optical fibers in circular buffer tubes, because rectangular/square shapes are formed when stacking these flat optical fiber ribbons. It is possible to package flat optical ribbons in loose tube cable structures, such as the AccuTube cable manufactured by OFS Fitel, but the resulting cables are too large to be used for microduct applications. Therefore, the use of stacked, flat optical fiber ribbons is not a suitable approach for a loose tube microcable application. Central tube microcables can incorporate flat optical fiber ribbons, however, those designs have a drawback of having one or more relatively small, rigid strength member reinforcements on the outside of the cable, resulting in relatively poor installation performance. Loose tube cables, which typically use a relatively large, rigid strength member rod in the center of the cable, generally exhibit better installation performance, as their relatively high rigidity makes it easier to “push” these cables with air. An additional problem with conventional loose tube microcables with loose optical fiber is that they do not support mass fusion splicing unless the installer takes the time-consuming step of field-ribbonizing the optical fiber.

### SUMMARY OF THE INVENTION

The invention is embodied in an optical fiber cable. The optical fiber cable includes at least one multi-fiber unit tube. The multi-fiber unit tube is substantially circular and dimensioned to receive a plurality of optical fibers. The optical fiber cable also includes at least one rollable optical fiber ribbon comprising a plurality of optical fibers positioned within the at least one multi-fiber unit tube. The plurality of optical fibers in the at least one rollable optical fiber ribbon are rolled in such a way that the at least one rollable optical fiber ribbon is formed in a variable shape. The optical fiber cable also includes a jacket surrounding the at least one multi-fiber unit tube.

### BRIEF DESCRIPTION OF THE DRAWINGS

FIG. 1A is a perspective view of a conventional partially bonded optical fiber ribbon;

FIG. 1B is a perspective view of another conventional partially bonded optical fiber ribbon;

FIG. 1C is a perspective view of yet another conventional partially bonded optical fiber ribbon;

FIG. 2 is a top view of a partially bonded optical fiber ribbon, according to embodiments of the invention;

FIG. 3A is a perspective view of a rollable ribbon, prior to being rolled, according to embodiments of the invention;

FIG. 3B is a perspective view of the rollable ribbon of FIG. 3A, after being rolled, according to embodiments of the invention;

FIG. 4 is a cross-sectional view of a conventional multi-fiber unit tube structure having a conventional stack of flat optical fiber ribbons housed therein, and a cross-sectional view of a multi-fiber unit tube structure having a plurality of rollable optical fiber ribbons housed therein, according to embodiments of the invention;

FIG. 5 is a cross-sectional view of a loose-tube cable structure having a plurality of loose tubes with rollable optical fiber ribbons housed therein, according to embodiments of the invention;

FIG. 6 is a cross-sectional view of another loose-tube cable structure having a plurality of loose tubes with rollable optical fiber ribbons housed therein, according to embodiments of the invention;

FIG. 7 is a cross-sectional view of yet another loose-tube cable structure having a plurality of loose tubes with rollable optical fiber ribbons housed therein, according to embodiments of the invention; and

FIG. 8 is a cross-sectional view of still another loose-tube cable structure having a plurality of loose tubes with rollable optical fiber ribbons housed therein, according to embodiments of the invention.

### DETAILED DESCRIPTION OF EXEMPLARY EMBODIMENTS

In the following description like reference numerals indicate like components to enhance the understanding of the invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

Some existing optical fiber cable manufacturers have developed a partially bonded optical fiber ribbon, also referred to as a rollable ribbon or pliable ribbon, where the optical fibers forming the optical fiber ribbon are not bonded over their entire length. The optical fibers are bonded intermittently, thus allowing the optical fibers of the optical fiber ribbon the flexibility to be folded or rolled about an axis parallel to the fibers so that the optical fiber ribbon can take on a variable shape, e.g., an approximately round cylindrical shape or as a relatively compact bundle with an approximately cylindrical shape or other suitable shape. In this manner, the shape of the optical fiber ribbon conforms to the shape of adjacent optical fiber ribbons along its length thereby reducing any space between them. The ability of the optical fibers of the optical fiber ribbon to be folded or rolled allows for better filling of a circular cable within which the optical fiber ribbon is positioned, resulting in more optical fibers to be included in a given cable diameter compared to optical fiber cables with conventional fully bonded ribbon structures.

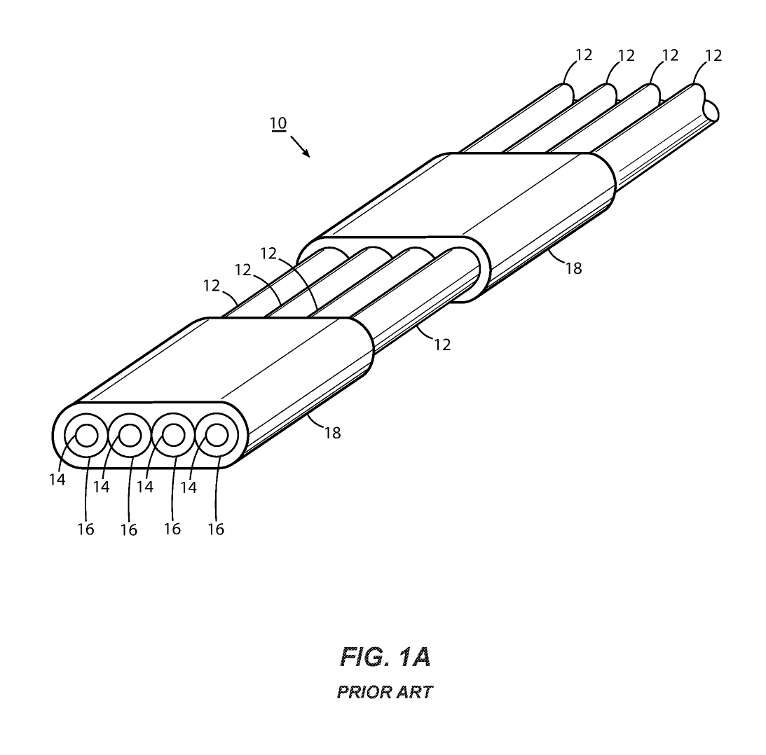

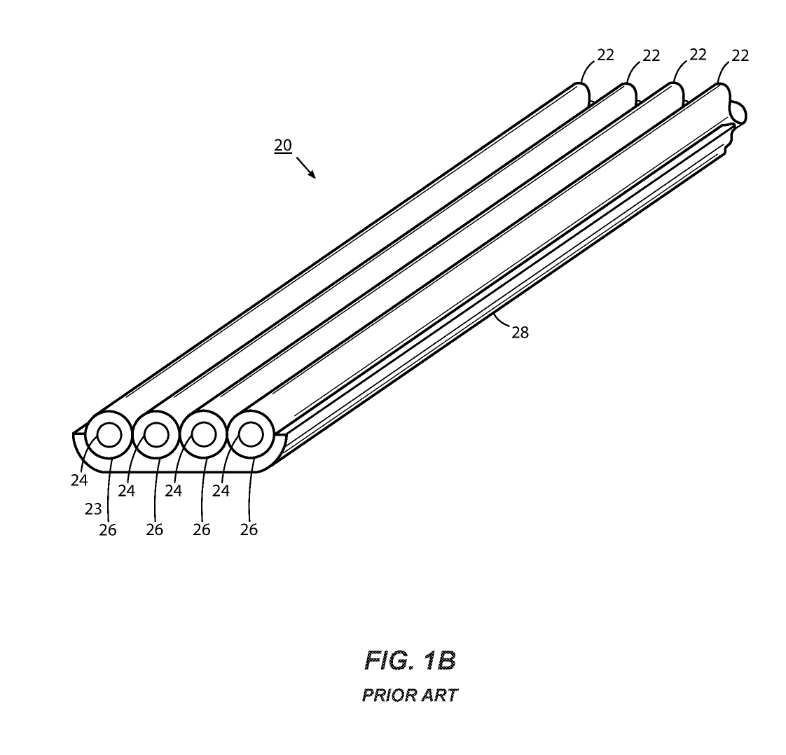

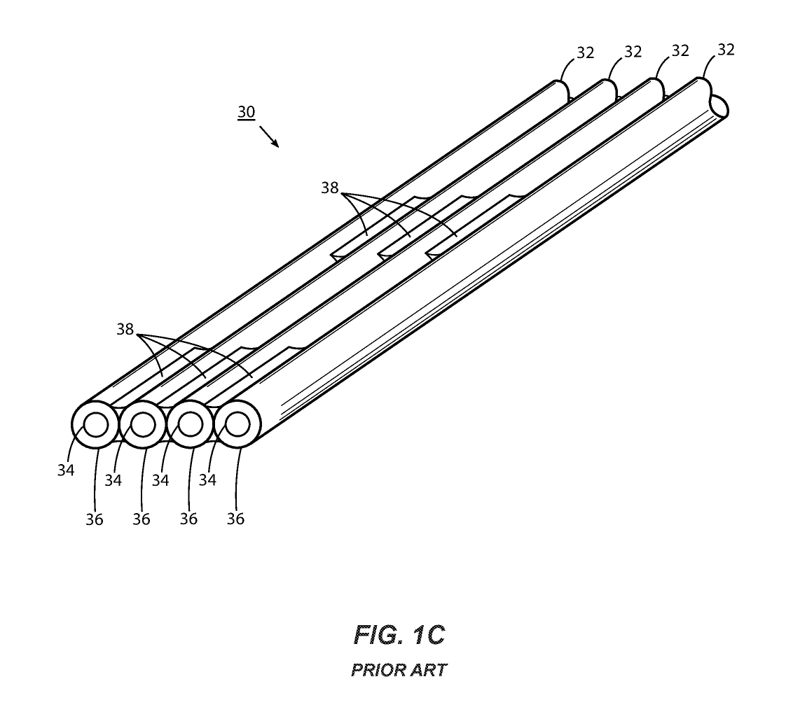

FIG. 1A is a perspective view of a conventional partially bonded optical fiber ribbon 10. As shown, the ribbon 10 includes a plurality of optical fibers 12, with each optical fiber 12 having a core portion 14 and a cladding portion 16. In this optical fiber ribbon 10, the entire periphery of the optical fibers 12 are intermittently covered with a ribbon matrix portion 18, if the matrix is relatively soft but tough.

FIG. 1B is a perspective view of another conventional partially bonded optical fiber ribbon 20. The optical fiber ribbon 20 in FIG. 1B includes a plurality of optical fibers 22, with each optical fiber 22 having a core portion 24 and a cladding portion 26. In this optical fiber ribbon 20, a portion of the periphery of the optical fibers 22 are covered with a ribbon matrix portion 28 along the entire length of the optical fibers 22, if the matrix is relatively soft but tough.

FIG. 1C is a perspective view of yet another conventional partially bonded optical fiber ribbon 30. The optical fiber ribbon 30 in FIG. 1C includes a plurality of optical fibers 32, with each optical fiber 32 having a core portion 34 and a cladding portion 36. In this optical fiber ribbon 30, portions of the periphery of the optical fibers 32 are intermittently covered with a ribbon matrix portion 38. As shown, the ribbon matrix portions 38 are uniformly displaced along the periphery of the optical fibers 32. The optical fiber ribbon 30 can be made by applying dots of matrix material in a pattern before curing, slicing a standard ribbon very precisely with a blade, or inserting pins to intermittently block the flow of liquid prepolymer matrix material.

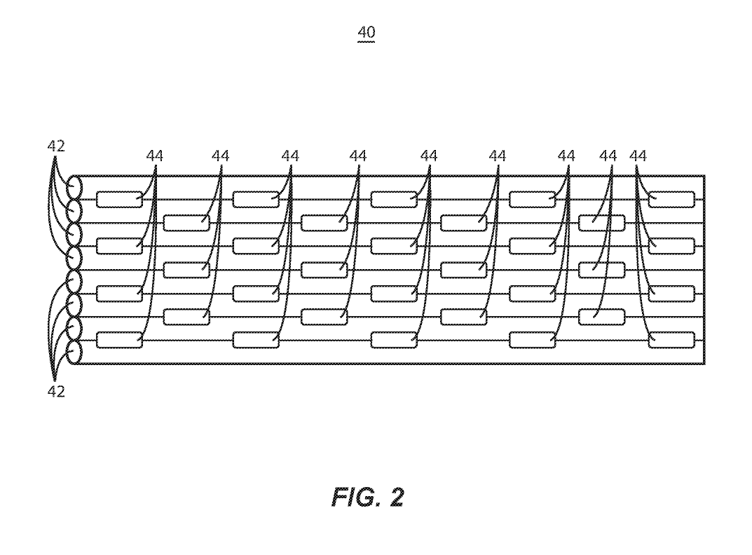

FIG. 2 is a top view of a partially bonded optical fiber ribbon 40, e.g., a partially bonded optical fiber ribbon suitable for use as a rollable ribbon, according to embodiments of the invention. The optical fiber ribbon 40 includes a plurality of optical fibers 42 linearly arranged as a ribbon. Each optical fiber, which has a core portion and a cladding portion around the core portion, is approximately 250 microns (μm) in diameter, although each optical fiber could have a diameter of approximately 200 μm or a smaller or larger diameter, based on the needs of the application. The optical fiber ribbon 40 also includes a plurality of ribbon matrix portions 44, which are applied in a suitable manner to various portions between adjacent optical fibers 42. As shown, the ribbon matrix portions 44 can be applied in a uniform pattern across the optical fibers 42. According to embodiments of the invention, the ribbon matrix portions 44 are applied to the optical fibers in such a manner that adjacent optical fibers 42 remain connected to one another, thus remaining an optical fiber ribbon, but also in a manner that allows the optical fiber ribbon 40 to be rolled and/or folded into one of a plurality of more densely configured unit shapes, as will be discussed in greater detail hereinbelow.

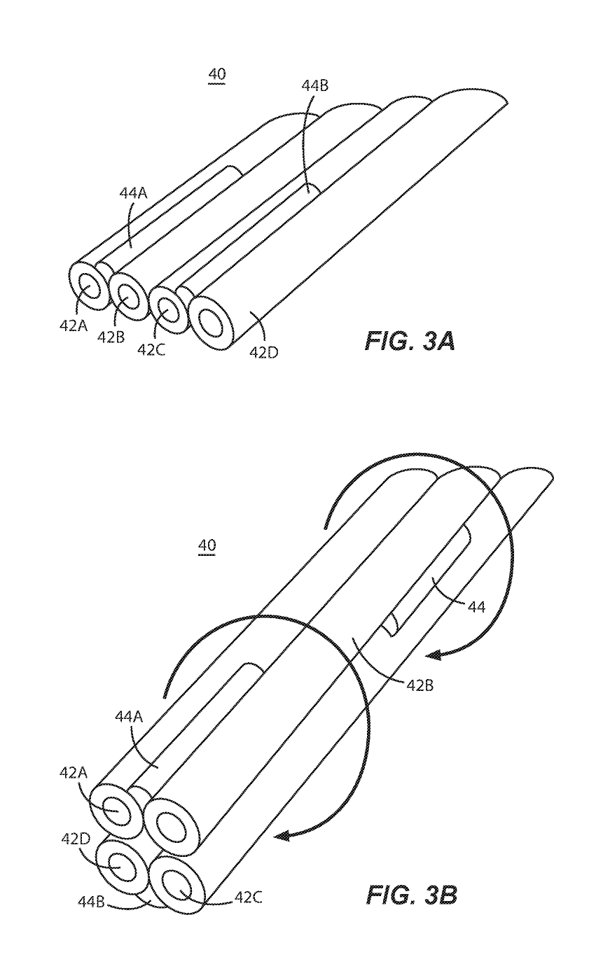

FIG. 3A is a perspective view of a rollable ribbon 40, prior to being rolled, according to embodiments of the invention. The rollable optical fiber ribbon 40 includes a plurality of optical fibers 42, e.g., optical fibers 42A-D, for a 4-fiber rollable optical fiber ribbon. Prior to being rolled, the optical fibers 42A-D in the rollable optical fiber ribbon 40 exist as a linear array of partially bonded optical fibers.

FIG. 3B is a perspective view of the rollable ribbon 40 of FIG. 3A, after being rolled, according to embodiments of the invention. As shown, the optical fibers 42A-D are rolled and/or folded into a more densely configured unit shape, e.g., in a generally circular shape, as shown. As discussed hereinabove, because of the specific structure of the rollable optical fiber ribbon 40, e.g., being a partially bonded optical fiber ribbon or an optical fiber ribbon having other suitable structure, the rollable optical fiber ribbon 40 is able to be rolled and/or folded into a more densely configured unit shape.

As discussed hereinabove, one limitation to increasing optical fiber count per buffer tube is the identification of optical fibers based on color. Any extension beyond the current 12 distinct optical fiber colors conventionally requires unique tracer identification, generally using ring-marking of the optical fiber, where identification marks are applied by conventional means. However, adding these tracers is undesirable, as the tracers may adversely affect the manufacturability and quality of the optical fiber itself. Also, as discussed hereinabove, the conventional use of flat optical fiber ribbons for increased optical fiber count per buffer tube prevents tight-packing of optical fibers in circular buffer tubes because rectangular/square shapes are formed when stacking these flat optical fiber ribbons.

According to embodiments of the invention, the use of rollable optical fiber ribbons, e.g., partially bonded rollable optical fiber ribbons, offers a hybrid solution to attain greater fiber count microcables. The use of rollable optical fiber ribbons allows for the identification of optical fibers beyond the twelve standard colors, without using the tracers as mentioned above. Accordingly, normal coloring processes can be applied to the rollable optical fiber ribbon fibers, thereby eliminating the adverse manufacturing effects and optical fiber quality issues associated with adding tracers directly on the surface of the colored optical fibers.

According to embodiments of the invention, one way to avoid the use of tracers is to vary the sequence of fiber colors for each rollable optical fiber ribbon. For example, if a first rollable optical fiber ribbon is blue-orange-green-brown, a second rollable optical fiber ribbon can be blue-green-brown-orange. In this manner, the first rollable optical fiber ribbon can be distinguished from the second rollable optical fiber ribbon because the optical fibers in each rollable optical fiber ribbon are joined together.

According to embodiments of the invention, another way to avoid the use of tracers is by printing on the rollable optical fiber ribbon, e.g., using an ink-jet printer, such as a VideoJet printer. Printing on the rollable optical fiber ribbon, e.g., using an ink-jet printer, allows a marking ink of any number of readable characters to be printed directly on the rollable optical fiber ribbon for identification. Printing on the rollable optical fiber ribbon, e.g., using an ink-jet printer, is extremely desirable because such printing on the rollable optical fiber ribbon can be performed during the ribbon manufacturing process without the need for a change in line speed or productivity.

By controlling the line pay-off and take-up to have a certain amount of tension, and by controlling the guide roller to have a certain amount of width, printing on the rollable optical fiber ribbon can be performed at a relatively high rate of speed with suitable legibility, even though the surface of the rollable optical fiber ribbon is not uniform like that of a flat optical fiber ribbon. Therefore, printing on the rollable optical fiber ribbon, e.g., using an ink-jet printer, eliminates the need for an additional process of applying wrapping binder thread around the rollable optical fiber ribbon (as well as the inconvenience of having to remove the binder thread during fiber installation).

Another advantage to printing on the rollable optical fiber ribbon instead of using tracers on 200 or 250 micron loose fiber is that printing allows a readable legend or markings to be printed on the rollable optical fiber ribbon, instead of one or more dashes when using tracers. For example, a readable legend, such as “1-AW-1” (e.g., for AllWave ribbon 1) can be printed on the rollable optical fiber ribbon. Also, because a readable legend can be printed on the rollable optical fiber ribbon, the distance between readable markings can be spaced out, which can help compensate for any attenuation effects of the printing. Also, printing a readable legend on the rollable optical fiber ribbon allows for fewer passes to achieve suitable identification for the rollable optical fiber ribbon. For example, if you have 24 optical fibers per tube, using tracer identification requires 12 ring-marking passes. However, for a 24-fiber tube using two 12-fiber rollable or flat optical fiber ribbons, printing on the ribbon only requires 2 ribboning passes. For 48 optical fibers per tube, using tracer identification requires 36 ring-marking passes, while printing for a 48-fiber tube using four 12-fiber rollable or flat optical fiber ribbons requires only 4 ribboning passes.

Another advantage of using rollable ribbons is that it simplifies tube manufacturing equipment. To manufacture a microcable buffer tube with 48 loose fibers, you need a large, relatively expensive payoff with 48 different spindles. In contrast, to make a 48-fiber buffer tube with 4-fiber ribbons, you only need 12 payoff spindles, which is common for the manufacture of 12-fiber tubes. In a preferred embodiment using 12-fiber rollable ribbons, only 4 payoff positions are needed in the loose-tube manufacturing process.

Also, the use of rollable optical fiber ribbons allows for a more circular cross-section of optical fibers than that offered by stacked, flat optical fiber ribbons. Consequently, buffer tubes can have a reduced cross-sectional area to better match that of the rollable optical fiber ribbons housed therein.

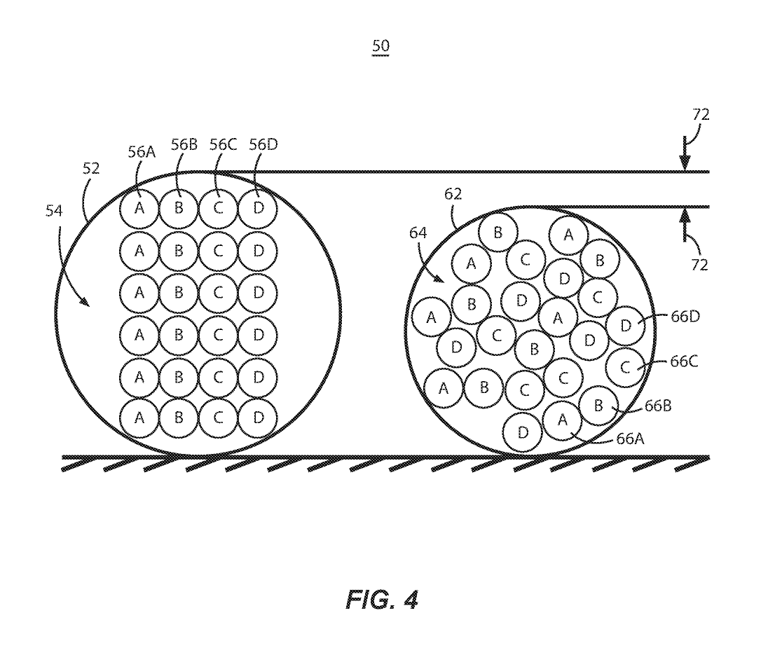

FIG. 4 is a cross-sectional view of a conventional multi-fiber unit tube structure 52 having a conventional stack of flat optical fiber ribbons 54 housed therein, and a cross-sectional view of a multi-fiber unit tube structure 62 having a plurality of rollable optical fiber ribbons 64 housed therein, according to embodiments of the invention. The conventional multi-fiber unit tube structure 52 includes a plurality of stacked, flat optical fiber ribbons 54, e.g., a stack of six 4-fiber (shown as optical fibers 56A-D) flat optical fiber ribbons (24 optical fibers total).

By comparison, the multi-fiber unit tube structure 62 includes a plurality of rollable optical fiber ribbons 64 that are rolled and/or folded into more densely configured unit shapes, e.g., generally circular shapes and other shapes. For example, each rollable optical fiber ribbon 64 is a 4-fiber (shown as optical fibers 66A-D) rollable optical fiber ribbon 64. As shown, each rollable optical fiber ribbon 64 (each having optical fibers 66A-D) is rolled and/or folded into a more densely configured unit shape. As a result, the rollable optical fiber ribbons 64 allows for a more circular cross-section of optical fibers than that offered by the stacked, flat optical fiber ribbons 54. As shown, for the same number of optical fibers (24), the multi-fiber unit tube structure 62 housing the rollable optical fiber ribbons 64 has a smaller diameter than the multi-fiber unit tube structure 52 housing the stacked, flat optical fiber ribbons 54. The difference in diameter between the multi-fiber unit tube structure 62 and the multi-fiber unit tube structure 52 is shown generally as a distance 72.

Also, in addition to increased optical fiber density, another advantage of using rollable optical fiber ribbons is the ability to use mass fusion splicing, which is the fusing of multiple optical fibers at a time, as opposed to fusing just one optical fiber at a time. The ability to use mass fusion splicing is a rather distinct feature of a cable product/family that employs the use of rollable optical fiber ribbons, because microcables largely employ loose fibers in their designs.

For example, when housing rollable optical fiber ribbons into a multi-fiber unit tube structure, the rollable optical fiber ribbons can be forced into roughly cylindrical shapes (and other suitable shapes). However, when rollable optical fiber ribbons are made, and when rollable optical fiber ribbons are taken out of their multi-fiber unit tube structure, each rollable optical fiber ribbon wants to lay flat, with the matrix material holding the individual optical fibers in sequential order. With the rollable optical fiber ribbon lying flat, the rollable optical fiber ribbon can be directly fusion spliced using the same methods used for fusion splicing conventional flat optical fiber ribbons.

The use of rollable optical fiber ribbons in microcables with 12, 24, 36, 48 or 72 optical fibers per multi-fiber unit tube provides at least the same packing density as conventional loose optical fiber or multi-fiber unit tube cables. However, even for cables with the same optical fiber packing density, the use of rollable optical fiber ribbons within multi-fiber unit tube microcables provides labor savings for installers by supporting mass fusion splicing.

For conventional flat optical fiber ribbon stack structures, such as the multi-fiber unit tube structure 52 shown in FIG. 4, typical ribbon stack structure designs have a ratio of the diagonal dimension of the flat optical fiber ribbon stack to the inner diameter of the loose tube of 0.70, with a few ribbon stack structure designs having a ratio of 0.80. An example of a tube design with the 0.80 ratio is a 6.0 mm inner diameter tube with twelve flat ribbons positioned therein, with each flat ribbon composed of twelve 250 micron diameter fibers, for a total of 144 fibers. Accordingly, the ratio of the total fiber cross-sectional area of the optical fibers to the cross-sectional area inscribed by the inner diameter of the tube is 0.25.

By comparison, for rollable optical fiber ribbon structures according to embodiments of the invention, such as the multi-fiber unit tube structure 62 shown in FIG. 4, the optimal fiber density largely based on performance is eight 250 micron diameter fibers per square millimeter. Converting this fiber density over to the ratio of area occupied by the fibers to the area both occupied and not occupied by the fibers yields a ratio of 0.39. The area both occupied and not occupied by the fibers is analogous to the area inscribed by the inner diameter of the tube in the flat ribbon example above. Thus, the use of rollable optical fiber ribbon structures according to embodiments of the invention provides an increase in fiber density based on cross-sectional areas of just under 60% relative to that of the flat ribbon example above.

As shown by the comparisons discussed hereinabove, the use of rollable optical fiber ribbons offers an improved compactness compared to conventional flat optical fiber ribbons. Also, as discussed hereinabove, the use of rollable optical fiber ribbons offers an improved identification scheme compared to conventional optical fibers with tracers (i.e., ring-marked optical fibers).

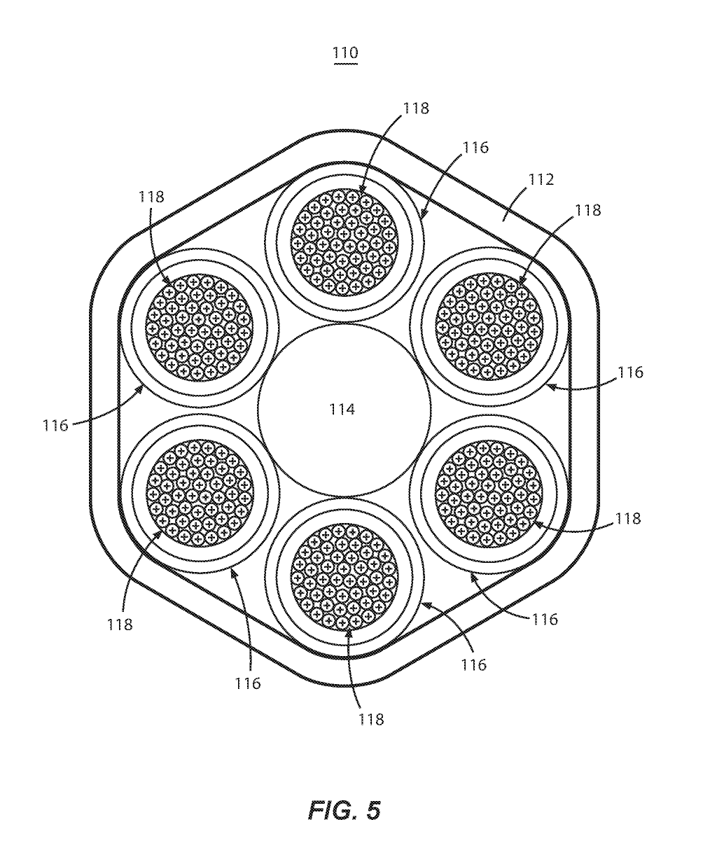

FIG. 5 is a cross-sectional view of a loose-tube cable structure 110 having a plurality of loose tubes with rollable optical fiber ribbons housed therein, according to embodiments of the invention. The cable structure 110 includes an outer sheath or jacket 112, a central strength member 114, and a plurality of multi-fiber unit tube structures 116 (e.g., six multi-fiber unit tube structures) positioned around the central strength member 114. Within each multi-fiber unit tube structure 116 is a plurality of rollable optical fiber ribbons 118 housed therein, e.g., six 8-fiber rollable optical fiber ribbons (i.e., 48 optical fibers total per multi-fiber unit tube structure). Thus, the cable structure 110 houses 288 optical fibers therein (6 loose tubes×48 optical fibers per loose tube).

Each multi-fiber unit tube structure 116 can be made of any suitable material. For example, each multi-fiber unit tube structure 116 can be made of polypropylene, polybutylene terephthalate (PBT), polyethylene, nylon, polycarbonate, thermoplastic polyurethane (TPU), poly(vinyl chloride) (PVC) or other suitable material or materials. Flame retardant additives may be incorporated into the multi-fiber unit tube structure 116 to help impart fire resistance, which may be desirable if some or all of the cable is deployed inside a building. Also, one or more dry water swellable materials may be incorporated into the multi-fiber unit tube structure 116 to block water penetration therein. The multi-fiber unit tube structure 116 can be a homogeneous tube. Alternatively, the multi-fiber unit tube structure 116 can be a multi-layer tube produced by coextrusion.

The outer sheath or jacket 112 can be made of any suitable material. For example, the jacket 112 can be made of polyethylene, thermoplastic polyurethane, nylon 12, or other suitable material. Flame-retardant additives may be incorporated into the jacket 112 to impart fire resistance to the cable. In one embodiment, the jacket 112 is made from high-density polyethylene (HDPE), with a nominal jacket thickness of approximately 0.5 mm or less. For microcable applications, it is desirable to use the thinnest possible jacket that can be fabricated without pinholes or other defects.

As discussed hereinabove, because of its specific structure, e.g., being a partially bonded optical fiber ribbon or an optical fiber ribbon having other suitable structure, each rollable optical fiber ribbon 118 can be rolled and/or folded into one or more densely configured unit shapes, as shown. For example, each rollable optical fiber ribbon 118 can be rolled into a circular or somewhat circular shape, so that the rollable optical fiber ribbons 118, either individually or collectively, more closely resemble the shape of their respective multi-fiber unit tube structure 116 compared to a conventional stack of flat optical fiber ribbons or other conventional optical fiber ribbons arrangements.

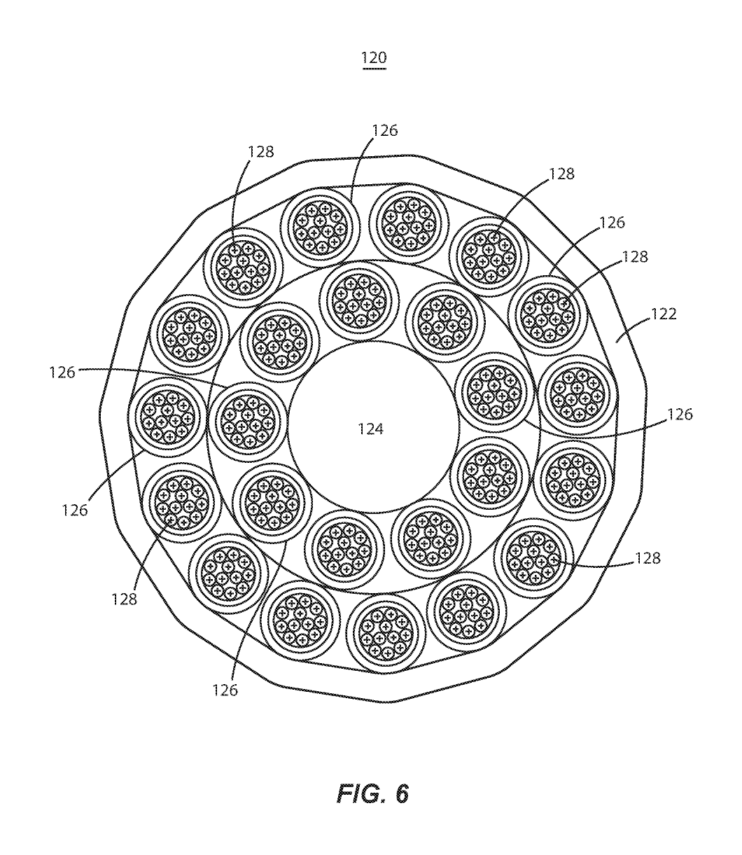

FIG. 6 is a cross-sectional view of another loose-tube cable structure 120 having a plurality of multi-fiber unit tube structures with rollable optical fiber ribbons housed therein, according to embodiments of the invention. The cable structure 120 includes an outer sheath or jacket 122, a central strength member 124, and a plurality of multi-fiber unit tube structures 126 (e.g., 24 multi-fiber unit tube structures) positioned in a first layer around the central strength member 124 and a second layer positioned around the first layer. Within each multi-fiber unit tube structure 126 is a rollable optical fiber ribbon 128 housed therein, e.g., a 12-fiber rollable optical fiber ribbon (i.e., 12 optical fibers per multi-fiber unit tube structure). Thus, the cable structure 120 houses 288 optical fibers therein (24 multi-fiber unit tube structures×12 optical fibers per multi-fiber unit tube structure). Also, one or more dry water swellable materials may be incorporated into the multi-fiber unit tube structure 126 to block water penetration therein.

Both loose-tube cable structures 110, 120 have an outer diameter of approximately 10.2 mm. However, the loose-tube cable structure 110 in FIG. 5 can promote better mass fusion splicing and higher optical fiber counts per loose tube than the loose-tube cable structure 120 in FIG. 6.

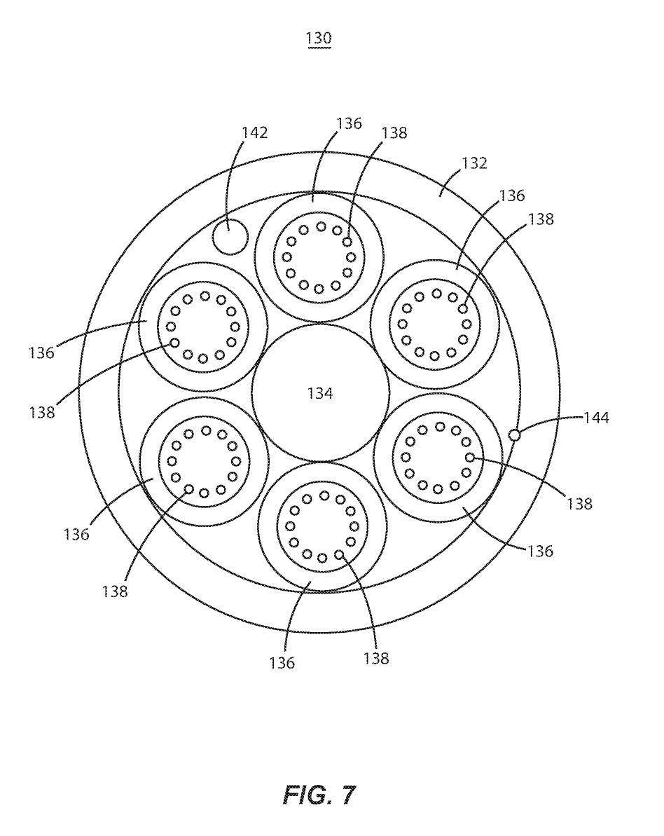

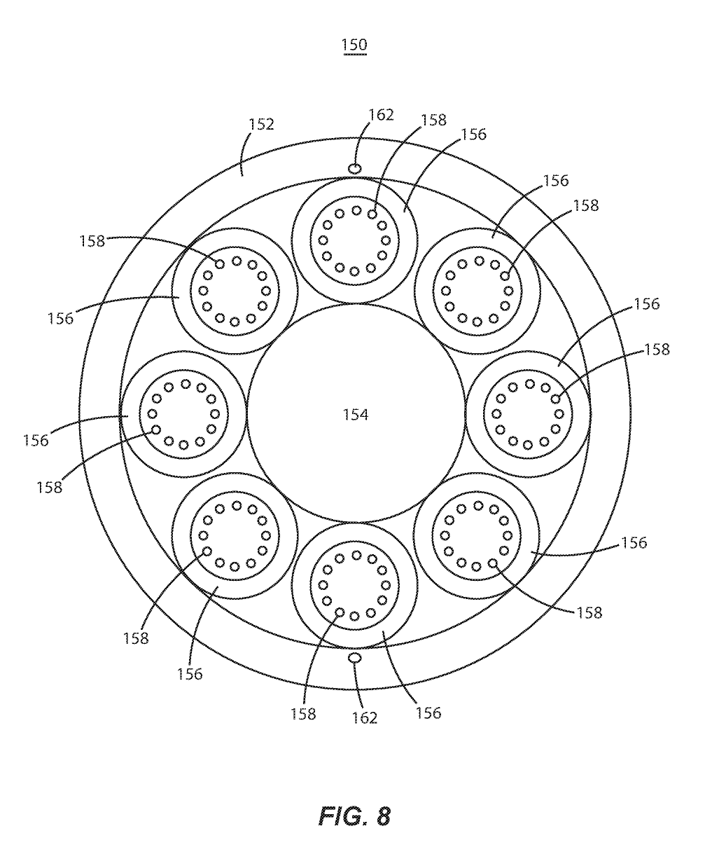

FIG. 7 is a cross-sectional view of yet another loose-tube cable structure 130 having a plurality of multi-fiber unit tube structures with rollable optical fiber ribbons housed therein, according to embodiments of the invention. The cable structure 130 includes an outer sheath or jacket 132, a non-metallic central strength member 134, and a plurality of multi-fiber unit tube structures 136 (e.g., 6 multi-fiber unit tube structures) positioned around the central strength member 134. Within each multi-fiber unit tube structure 136 is a rollable optical fiber ribbon 138 housed therein, e.g., a 12-fiber rollable optical fiber ribbon (i.e., 12 optical fibers per multi-fiber unit tube structure). Thus, the cable structure 130 houses 72 optical fibers therein (6 multi-fiber unit tube structures×12 optical fibers per multi-fiber unit tube structure). The loose-tube cable structure 130 also can include a copper tracer 142 for reference, and a ripcord 144.

Each multi-fiber unit tube structure 136 can be made of any suitable material. For example, each multi-fiber unit tube structure 136 can be made of polypropylene, polybutylene terephthalate (PBT), polyethylene, nylon, polycarbonate, thermoplastic polyurethane (TPU), poly(vinyl chloride) (PVC) or other suitable material or materials. One or more dry water swellable materials may be incorporated into the multi-fiber unit tube structure 136 to block water penetration therein. The multi-fiber unit tube structure 136 can be a homogeneous tube. Alternatively, the multi-fiber unit tube structure 136 can be a multi-layer tube produced by coextrusion. In one embodiment, in which the rollable ribbon 138 is made from 250 micron optical fiber, each multi-fiber unit tube structure 136 has a thickness of 0.25 mm, an outer diameter of 1.70 mm, and an inner diameter of 1.20 mm.

The outer sheath or jacket 132 can be made of any suitable material. For example, the jacket 132 can be made of polyethylene, thermoplastic polyurethane, nylon 12, or other suitable material. Flame-retardant additives may be incorporated into the jacket 132 to impart fire resistance to the cable. In one embodiment, the jacket 132 is made from high-density polyethylene (HDPE), with a nominal jacket thickness of approximately 0.50 mm or less, and an outer diameter of 6.40 mm.

FIG. 8 is a cross-sectional view of still another loose-tube cable structure 150 having a plurality of multi-fiber unit tube structures with rollable optical fiber ribbons housed therein, according to embodiments of the invention. The cable structure 150 includes an outer sheath or jacket 152, a non-metallic central strength member 154, and a plurality of multi-fiber unit tube structures 156 (e.g., 8 multi-fiber unit tube structures) positioned around the central strength member 154. Within each multi-fiber unit tube structure 156 is a rollable optical fiber ribbon 158 housed therein, e.g., a 12-fiber rollable optical fiber ribbon (i.e., 12 optical fibers per multi-fiber unit tube structure). Thus, the cable structure 150 houses 96 optical fibers therein (8 multi-fiber unit tube structures×12 optical fibers per multi-fiber unit tube structure). The loose-tube cable structure 150 also can include a ripcord 162.

Each multi-fiber unit tube structure 156 can be made of any suitable material. For example, each multi-fiber unit tube structure 156 can be made of polypropylene, polybutylene terephthalate (PBT), polyethylene, nylon, polycarbonate, thermoplastic polyurethane (TPU), poly(vinyl chloride) (PVC) or other suitable material or materials. One or more dry water swellable materials may be incorporated into the multi-fiber unit tube structure 156 to block water penetration therein. The multi-fiber unit tube structure 156 can be a homogeneous tube. Alternatively, the multi-fiber unit tube structure 156 can be a multi-layer tube produced by coextrusion. In one embodiment, each multi-fiber unit tube structure 156 has a thickness of 0.20 mm, an outer diameter of 1.50 mm, and an inner diameter of 1.10 mm.

The outer sheath or jacket 152 can be made of any suitable material. For example, the jacket 152 can be made of polyethylene, thermoplastic polyurethane, nylon 12, or other suitable material. Flame-retardant additives may be incorporated into the jacket 152 to impart fire resistance to the cable. In one embodiment, the jacket 152 is made from high-density polyethylene (HDPE), with a nominal jacket thickness of approximately 0.5 mm or less, and an outer diameter of 6.50 mm.

It will be apparent to those skilled in the art that many changes and substitutions can be made to the embodiments of the invention herein described without departing from the spirit and scope of the invention as defined by the appended claims and their full scope of equivalents.

1. An optical fiber cable, comprising:
at least one multi-fiber unit tube, wherein the multi-fiber unit tube is substantially circular and dimensioned to receive a plurality of optical fibers;
at least one rollable optical fiber ribbon comprising a plurality of optical fibers positioned within the at least one multi-fiber unit tube, wherein the plurality of optical fibers in the at least one rollable optical fiber ribbon are rolled in such a way that the at least one rollable optical fiber ribbon is formed in a variable shape; and
a jacket surrounding the at least one multi-fiber unit tube,
wherein the at least one multi-fiber unit tube has positioned therein a plurality of rollable optical fiber ribbons having at least 48 total optical fibers, and
wherein the at least one multi-fiber unit tube has a ratio of total optical fiber cross-sectional area to the area inscribed by the inner diameter of the multi-fiber unit tube of at least approximately 0.39.

2. (canceled)

3. (canceled)

4. (canceled)

5. The optical fiber cable as recited in claim 1, wherein the at least one rollable optical fiber ribbon includes at least one marking ink of at least one printable character, wherein the at least one marking ink of at least one printable character is printed on the at least one rollable optical fiber ribbon using an ink-jet printer.

6. The optical fiber cable as recited in claim 1, wherein the at least one rollable optical fiber ribbon is rolled in such a way that the optical fibers within the at least one rollable optical fiber ribbon can be identified without the use of tracer ring-markings on the optical fibers.

7. The optical fiber cable as recited in claim 1, wherein the at least one rollable optical fiber ribbon is rolled into a substantially circular shape.

8. The optical fiber cable as recited in claim 1, wherein the at least one rollable optical fiber ribbon has between four and twenty four optical fibers partially bonded together.

9. The optical fiber cable as recited in claim 1, wherein at least one of the multi-fiber unit tubes is dimensioned to position between two and eight rollable optical fiber ribbons therein.

10. The optical fiber cable as recited in claim 1, wherein at least one of the multi-fiber unit tubes is a made of a material selected from the group consisting of polypropylene, polyethylene, nylon, polycarbonate, polybutylene terephthalate (PBT), thermoplastic polyurethane (TPU) and poly(vinyl chloride) (PVC).

11. The optical fiber cable as recited in claim 1, wherein the jacket is made of a material selected from the group consisting of polyethylene, thermoplastic polyurethane, nylon 12, and poly(vinyl chloride) (PVC).

12. An optical fiber cable, comprising:
A plurality of multi-fiber unit tubes, wherein the multi-fiber unit tubes are substantially circular and dimensioned to receive a plurality of optical fibers;
at least one rollable optical fiber ribbon comprising a plurality of optical fibers positioned within at least one of the plurality of multi-fiber unit tubes, wherein the plurality of optical fibers in the at least one rollable optical fiber ribbon are rolled in such a way that the at least one rollable optical fiber ribbon is formed in a variable shape; and
a jacket surrounding the plurality of multi-fiber unit tubes,
wherein the at least one multi-fiber unit tube has positioned therein a plurality of rollable optical fiber ribbons having at least 48 total optical fibers, and
wherein the at least one multi-fiber unit tube has a ratio of total optical fiber cross-sectional area to the area inscribed by the inner diameter of the multi-fiber unit tube of at least approximately 0.39.

13. (canceled)

14. (canceled)

15. (canceled)

16. The optical fiber cable as recited in claim 12, wherein the optical fiber cable further comprises a central strength member, and wherein the plurality of multi-fiber unit tubes are positioned around the central member.

17. The optical fiber cable as recited in claim 16, wherein the plurality of multi-fiber unit tubes further comprises a first plurality of multi-fiber unit tubes positioned around the central strength member and a second plurality of multi-fiber unit tubes positioned around the first plurality of multi-fiber unit tubes.

18. The optical fiber cable as recited in claim 12, wherein the at least one rollable optical fiber ribbon includes at least one marking ink of at least one printable character, wherein the at least one marking ink of at least one printable character is printed on the at least one rollable optical fiber ribbon using an ink-jet printer

19. The optical fiber cable as recited in claim 12, wherein the at least one rollable optical fiber ribbon is rolled in such a way that the optical fibers within the at least one rollable optical fiber ribbon can be identified without the use of tracer ring-markings on the optical fibers.

20. The optical fiber cable as recited in claim 12, wherein the at least one rollable optical fiber ribbon has between four and twenty four optical fibers partially bonded together.
